(19) United States
(12) Patent Application Publication
(10) Pub. No.: US 2024/0304358 A1
(43) Pub. Date: Sep. 12, 2024

(54) FIRST WIRE HARNESS AND COMPOUND WIRE HARNESS

(71) Applicant: SUMITOMO WIRING SYSTEMS, LTD., Yokkaichi-shi (JP)

(72) Inventor: Katsutoshi IZAWA, Yokkaichi-shi (JP)

(73) Assignee: SUMITOMO WIRING SYSTEMS, LTD., Yokkaichi-shi (JP)

(21) Appl. No.: 18/277,421

(22) PCT Filed: Feb. 18, 2022
(86) PCT No.: PCT/JP2022/006591

§ 371 Date: Aug. 16, 2023

(30) Foreign Application Priority Data
Mar. 4, 2021 (JP) 2021-034232

(51) Int. Cl. H01B 7/00; B60R 16/02; H01R 13/52; H01R 13/6592

(52) U.S. Cl. CPC H01B 7/0045; B60R 16/0215; H01R 13/5202; H01R 13/5219; H01R 13/6592

(57) ABSTRACT

A first wire harness electrically connectable to a second wire harness for electrical connection to an in-vehicle device, the first wire harness including: a first wire including a first core wire and a first insulating coating covering the first core wire; a first terminal attached to an end of the first core wire and configured to be electrically connected to the second wire harness; a first connector housing covering the first core wire, the first insulating coating, and the first terminal; a first exterior ring that is electrically conductive, has a ring-shaped transverse sectional shape, and surrounds the first wire; and a shield that is electrically conductive, has a ring-shaped transverse sectional shape, and is attached to a lengthwise end of the first exterior ring.

### BACKGROUND

The present disclosure relates to a first wire harness and a compound wire harness.

Conventionally, a wire harness for use in a vehicle such as a hybrid vehicle or an electric automobile includes a wire member that electrically connects electrical devices such as a high-voltage battery and an inverter (see JP 6048859B, for example). This type of wire member includes a rigid wire, which is constituted by a core wire composed of a single conductor surrounded by an insulated coating, and flexible wires that are connected to the two ends of the rigid wire and are each constituted by a flexible core wire such as a stranded wire surrounded by an insulating coating.

### SUMMARY

In the above-described wire harness, there is desire for an improvement in the ease of installation in a vehicle.

An exemplary aspect of the disclosure provides a first wire harness and a compound wire harness that can improve the ease of installation in a vehicle.

A first wire harness according to an aspect of the present disclosure is a first wire harness electrically connectable to a second wire harness for electrical connection to an in-vehicle device, the first wire harness including: a first wire including a first core wire and a first insulating coating covering the first core wire; a first terminal attached to an end of the first core wire and configured to be electrically connected to the second wire harness; a first connector housing covering the first core wire, the first insulating coating, and the first terminal; a first exterior ring that is electrically conductive, has a ring-shaped transverse sectional shape, and surrounds the first wire; and a shield that is electrically conductive, has a ring-shaped transverse sectional shape, and is attached to a lengthwise end of the first exterior ring, wherein: the first exterior ring and the shield have a higher rigidity than the first wire, the shield is electrically connected to the first exterior ring, and the first connector housing is surrounded by the first exterior ring and the shield.

A compound wire harness according to an aspect of the present disclosure is a compound wire harness for installation in a vehicle, the compound wire harness including: a first wire harness; and a second wire harness configured to be electrically connected to an in-vehicle device and electrically connected to the first wire harness, the first wire harness including: a first wire including a first core wire and a first insulating coating covering the first core wire; a first terminal attached to an end of the first core wire; a first connector housing covering the first core wire, the first insulating coating, and the first terminal; a first exterior ring that is electrically conductive, has a ring-shaped transverse sectional shape, and surrounds the first wire; and a shield that is electrically conductive, has a ring-shaped transverse sectional shape, and is attached to a lengthwise end of the first exterior ring, and the second wire harness including: a second wire including a second core wire and a second insulating coating covering the second core wire; a second terminal attached to an end of the second core wire and configured to be electrically connected to the first terminal; a second connector housing holding the second terminal; and a second ring having a ring-shaped transverse sectional shape and surrounding the second wire, wherein the first exterior ring and the shield have a higher rigidity than the first wire, the shield is electrically connected to the first exterior ring, the first connector housing is surrounded by the first exterior ring and the shield, and the second wire and the second ring have a higher flexibility than the first exterior ring.

The first wire harness and the compound wire harness according to the above aspects of the present disclosure achieve an effect of enabling improving the ease of installation in a vehicle.

### BRIEF DESCRIPTION OF THE DRAWINGS

FIG. 1 is a schematic configuration diagram showing a compound wire harness according to an embodiment.

FIG. 2 is a schematic cross-sectional view of a wire harness according to an embodiment.

FIG. 3 is a schematic cross-sectional view of a compound wire harness according to an embodiment.

FIG. 4 is a schematic cross-sectional view (cross-sectional view taken along line 4-4 in FIG. 2) of a wire harness according to an embodiment.

FIG. 5 is a schematic cross-sectional view (cross-sectional view taken along line 5-5 in FIG. 2) of a wire harness according to an embodiment.

FIG. 6 is a schematic cross-sectional view of a compound wire harness according to a variation.

FIG. 7 is a schematic configuration diagram showing a compound wire harness according to a variation.

FIG. 8 is a schematic configuration diagram showing a compound wire harness according to a variation.

### DETAILED DESCRIPTION OF EMBODIMENTS

### Description of Embodiments of Present Disclosure

First, embodiments of the present disclosure will be listed and described.

(1) A first wire harness according to an aspect of the present disclosure is a first wire harness electrically connectable to a second wire harness for electrical connection to an in-vehicle device, the first wire harness including: a first wire including a first core wire and a first insulating coating covering the first core wire; a first terminal attached to an end portion of the first core wire and configured to be electrically connected to the second wire harness; a first connector housing covering the first core wire, the first insulating coating, and the first terminal; a first exterior member that is electrically conductive, has a ring-shaped transverse sectional shape, and surrounds the first wire; and a shielding member that is electrically conductive, has a ring-shaped transverse sectional shape, and is attached to a lengthwise end portion of the first exterior member, wherein the first exterior member and the shielding member have a higher rigidity than the first wire, the shielding member is electrically connected to the first exterior member, and the first connector housing is surrounded by the first exterior member and the shielding member.

According to this configuration, the first connector housing, which covers the first terminal for connection to the second wire harness, and the first wire are surrounded by the first exterior member and the shielding member that have a higher rigidity than the first wire. For this reason, the portion connected to the second wire harness (e.g., one lengthwise end portion of the first wire harness) can have a structure with excellent rigidity. Accordingly, a flexible portion can be omitted from the end portion on at least one side out of the lengthwise end portions of the first wire harness. As a result, the first wire harness can be installed in a vehicle more easily than in the case where a flexible portion is provided at both end portions.

Here, the term “ring-shaped” in this specification means a structure that is overall connected to form an unbroken ring, such as an endless structure whose start point and end point coincide with each other. Also, the term “ring-shaped” in this specification includes a circular ring whose outer edge is circular, a ring whose outer edge is elliptical or oval, a polygonal ring whose outer edge is polygonal, and a ring whose outer edge is shaped as a rounded-edge polygon, and refers to any closed shape whose outer edge is formed by connected straight lines or curved lines. The term “ring-shaped” includes a shape that has a through hole in a plan view, and the outer edge shape may be the same as the inner peripheral shape of the through hole, or the outer edge shape may be different from the inner peripheral shape of the through hole. The term “ring-shaped” includes a shape having a predetermined length along the axial direction in which the central axis of the through hole extends, and there are no limitations on the magnitude of the length. Also, the term “ring-shaped” in this specification need only be a shape that overall resembles a ring, and includes the case where a plurality of components combine to form a ring, and the case of partially including a notch or a slit as with a C-like shape.

(2) It is preferable that the first wire harness further includes a first sealing member that is ring-shaped and attached to an outer peripheral surface of the first connector housing, and the first sealing member is in close contact with the outer peripheral surface of the first connector housing and is in close contact with an inner peripheral surface of the first exterior member. According to this configuration, the first wire harness includes the first sealing member that is in close contact with the outer peripheral surface of the first connector housing and in close contact with the inner peripheral surface of the first exterior member. The first sealing member can achieve sealing between the first connector housing and the first exterior member, thus making it possible to suitably suppress the entrance of a liquid such as water into the first exterior member.

(3) It is preferable that the first wire harness further includes a second sealing member that is ring-shaped and attached to an outer peripheral surface of the first connector housing, and the second sealing member is in close contact with the outer peripheral surface of the first connector housing and is in close contact with an inner peripheral surface of the shielding member. According to this configuration, the first wire harness includes the second sealing member that is in close contact with the outer peripheral surface of the first connector housing and in close contact with the inner peripheral surface of the shielding member. The second sealing member can achieve sealing between the first connector housing and the shielding member, thus making it possible to suitably suppress the entrance of a liquid such as water into the shielding member.

(4) It is preferable that the first wire harness further includes a third sealing member covering an outer peripheral surface of the first exterior member and an outer peripheral surface of the shielding member, in a state of close contact, and the third sealing member extends across a region spanning the outer peripheral surface of the first exterior member and the outer peripheral surface of the shielding member. According to this configuration, the third sealing member extends across a region spanning the outer peripheral surface of the first exterior member and the outer peripheral surface of the shielding member, and covers the outer peripheral surface of the first exterior member and the outer peripheral surface of the shielding member, in a state of close contact with such members. The third sealing member can achieve sealing between the first exterior member and the shielding member at the connection between the first exterior member and the shielding member. Accordingly, it is possible to suitably suppress the case where a liquid such as water enters the first exterior member and the shielding member through the connection between the first exterior member and the shielding member.

(5) It is preferable that the first connector housing includes: a first end portion on a side corresponding to the first terminal; and a second end portion on a side opposite to the first end portion, and an outer peripheral surface of the second end portion includes a first guide portion inclined to approach the first wire while extending away from the first end portion. According to this configuration, the first guide portion is formed in the second end portion of the first connector housing. Accordingly, the first connector housing can be guided into the shielding member and into the first exterior member along the inclined surface of the first guide portion. For this reason, the first connector housing, which covers the first wire and the first terminal, can be easily inserted into the shielding member and the first exterior member. As a result, it is possible to improve the ease of assembly of the first wire harness.

(6) It is preferable that a lengthwise end portion of the shielding member is fitted around a lengthwise end portion of the first exterior member, the first connector housing further includes: a first covering portion accommodated inside the first exterior member; and a second covering portion accommodated inside the shielding member, and the second covering portion has a larger outer shape than the first covering portion, the outer shape of the second covering portion being set to a size according to which the second covering portion is not insertable into the first exterior member. According to this configuration, the size of the second covering portion of the first connector housing is set such that the second covering portion cannot be inserted into the first exterior member. Accordingly, when the first connector housing is inserted from the shielding member side toward the first exterior member, the first connector housing can be easily positioned inside the shielding member and inside the first exterior member. As a result, it is possible to improve the ease of assembly of the first wire harness.

(7) It is preferable that the first covering portion includes the first guide portion, and an outer peripheral surface of an end portion of the second covering portion that is connected to the first covering portion includes a second guide portion inclined to approach the first wire while extending toward the first covering portion. According to this configuration, the second guide portion is formed in the second covering portion. Accordingly, the first connector housing can be guided into the shielding member along the inclined surface of the second guide portion. For this reason, the first connector housing can be easily inserted into the shielding member. As a result, it is possible to improve the ease of assembly of the first wire harness.

(8) A compound wire harness according to an aspect of the present disclosure is a compound wire harness for installation in a vehicle, the compound wire harness including: a first wire harness; and a second wire harness configured to be electrically connected to an in-vehicle device and electrically connected to the first wire harness, the first wire harness including: a first wire including a first core wire and a first insulating coating covering the first core wire; a first terminal attached to an end portion of the first core wire; a first connector housing covering the first core wire, the first insulating coating, and the first terminal; a first exterior member that is electrically conductive, has a ring-shaped transverse sectional shape, and surrounds the first wire; and a shielding member that is electrically conductive, has a ring-shaped transverse sectional shape, and is attached to a lengthwise end portion of the first exterior member, and the second wire harness including: a second wire including a second core wire and a second insulating coating covering the second core wire; a second terminal attached to an end portion of the second core wire and configured to be electrically connected to the first terminal; a second connector housing holding the second terminal; and a second exterior member having a ring-shaped transverse sectional shape and surrounding the second wire, wherein the first exterior member and the shielding member have a higher rigidity than the first wire, the shielding member is electrically connected to the first exterior member, the first connector housing is surrounded by the first exterior member and the shielding member, and the second wire and the second exterior member have a higher flexibility than the first exterior member.

According to this configuration, the first connector housing, which covers the first terminal for connection to the second wire harness, and the first wire are surrounded by the first exterior member and the shielding member that have a higher rigidity than the first wire. For this reason, the portion connected to the second wire harness (e.g., one lengthwise end portion of the first wire harness) can have a structure with excellent rigidity. Accordingly, a flexible portion can be omitted from the end portion on at least one side out of the lengthwise end portions of the first wire harness. As a result, it is possible to improve the ease of installation of the first wire harness in a vehicle. Also, the first wire harness having excellent rigidity and the second wire harness having excellent flexibility can be separated from each other, thus enabling the first wire harness and the second wire harness to be separately installed in a vehicle. Accordingly, it is possible to improve the ease of installation of the compound wire harness in a vehicle.

(9) It is preferable that the second wire harness is integrated with the in-vehicle device, the second wire further includes: a second-wire first end portion to which the second terminal is attached; and a second-wire second end portion on a side opposite to the second-wire first end portion, and the second-wire second end portion is configured to be electrically connected to an electric circuit of the in-vehicle device, inside the in-vehicle device. According to this configuration, the second wire harness is integrated with the in-vehicle device, thus making it possible to omit the task of connecting the second wire harness to the in-vehicle device. Accordingly, the compound wire harness can be easily installed in a vehicle even if there is little routing space around the in-vehicle device, for example. For this reason, it is possible to improve the ease of installation of the compound wire harness in a vehicle.

### Details of Embodiments of Present Disclosure

Specific examples of a first wire harness and a compound wire harness according to the present disclosure will be described below with reference to the drawings. In the drawings, the configurations may be partially exaggerated or simplified for convenience in the description. Also, the dimensional ratios of various portions may differ among the drawings. Note that the present disclosure is not limited to these examples, but rather is indicated by the scope of the claims, and is intended to include all modifications within the scope and meaning equivalent to the scope of the claims.

### Overall Configuration of Compound Wire Harness 10

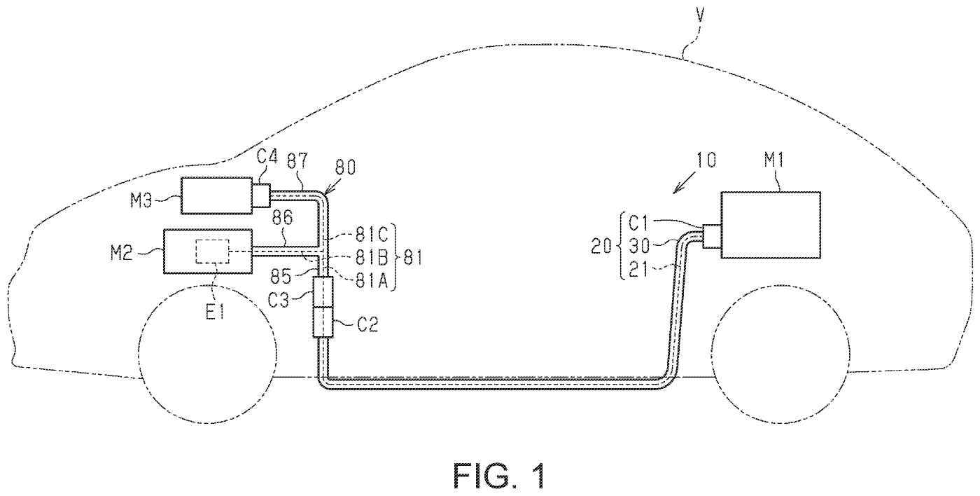

A compound wire harness 10 shown in FIG. 1 is for installation in a vehicle V such as a hybrid vehicle or an electric automobile, for example. The compound wire harness 10 electrically connects two in-vehicle devices or three or more in-vehicle devices to each other. Such in-vehicle devices are electric devices installed in the vehicle V. The compound wire harness 10 of the present embodiment electrically connects a high-voltage battery M1 to in-vehicle devices M2 and M3.

The battery M1 is provided toward the rear of vehicle V, for example. One example of the in-vehicle device M2 is an inverter installed forward of the battery M1 in the vehicle V. The battery M1 is a battery capable of supplying a voltage of 100 volts or more, for example. The in-vehicle device M2, which may be an inverter, is connected to a wheel drive motor (not shown) that serves as a motive power source for traveling of the vehicle, for example. The in-vehicle device M2, which may be an inverter, generates AC power from DC power received from the battery M1, and supplies the AC power to the motor. The in-vehicle device M3 is an electric device such as an air conditioner or a DC/DC converter, for example. The in-vehicle device M3 receives DC power from the battery M1. In this way, in the compound wire harness 10, DC power is distributed from the battery M1 to the in-vehicle devices M2 and M3. The in-vehicle devices M2 and M3 are provided in a vehicle compartment such as the engine room, for example.

Note that in the present embodiment, for convenience, “rear” refers to the side closer to the battery M1 in the length direction of the compound wire harness 10, and “front” refers to the side closer to the in-vehicle devices M2 and M3 in the length direction of the compound wire harness 10. Also, “rear end portion” refers to the end portion of a member located closer to the battery M1, and “front end portion” refers to the end portion of a member located closer the in-vehicle devices M2 and M3.

The compound wire harness 10 includes a wire harness 20 and a wire harness 80. The wire harness 20 is electrically connected to the battery M1, and is also electrically connected to the wire harness 80. The wire harness 20 includes a connector C1 and a connector C2. For example, the rear end portion of the wire harness 20 is connected to the battery M1 via the connector C1, and the front end portion of the wire harness 20 is connected to the wire harness 80 via the connector C2. The wire harness 80 is electrically connected to the in-vehicle devices M2 and M3, and is also electrically connected to the wire harness 20. The wire harness 80 includes a connector C3 that can be attached to and detached from the connector C2. The wire harness 20 and the wire harness 80 are electrically connected to each other by connecting the connector C2 and the connector C3 to each other.

### Configuration of Wire Harness 20

The wire harness 20 constitutes a portion of a high-voltage circuit that enables the transmission and reception of high-voltage power between the battery M1 and the wire harness 80, for example. The wire harness 20 is routed from the battery M1 to the wire harness 80, with a portion or all of the wire harness 20 in the length direction thereof passing under the floor of the vehicle V, for example.

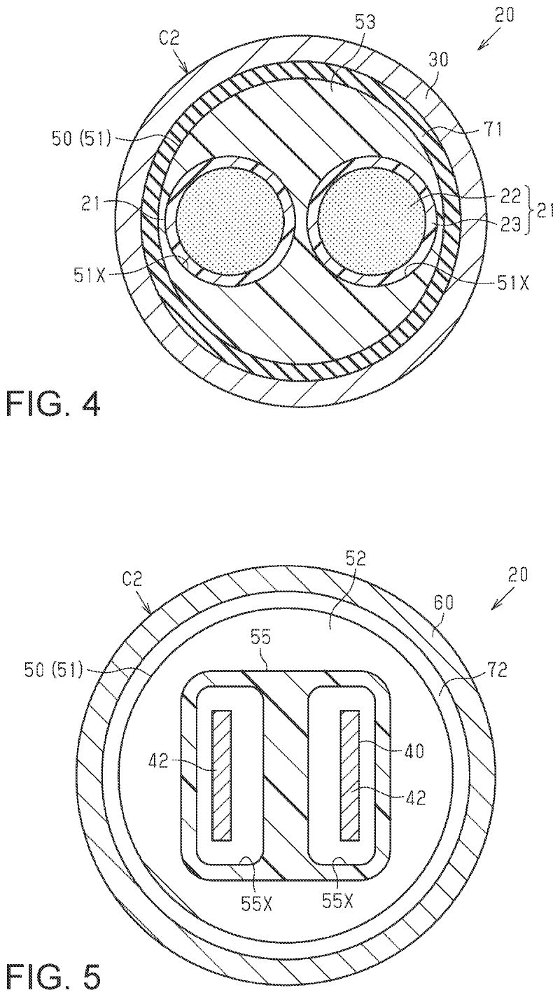

The wire harness 20 includes one or a plurality of (two in the example in FIG. 4) wires 21, the connector C1 attached to the rear end portions of the wires 21, the connector C2 attached to the front end portions of the wires 21, and an exterior member 30 (first exterior ring) that surrounds the wires 21. The wires 21 are elongated so as to extend in the front-rear direction of the vehicle V, for example. The wires 21 are high-voltage wires that can support high-voltage and high-current power, for example. The wires 21 may each be a shielded wire including an electromagnetic shielding structure, or may be a non-shielded wire not including an electromagnetic shielding structure, for example. The wires 21 of the present embodiment are non-shielded wires.

### Configuration of Wire 21

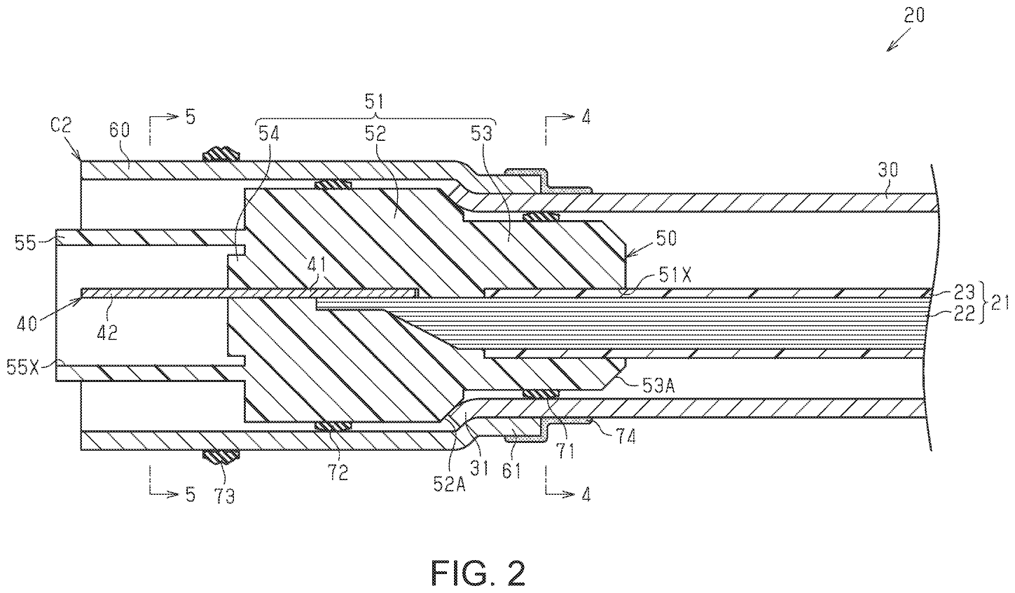

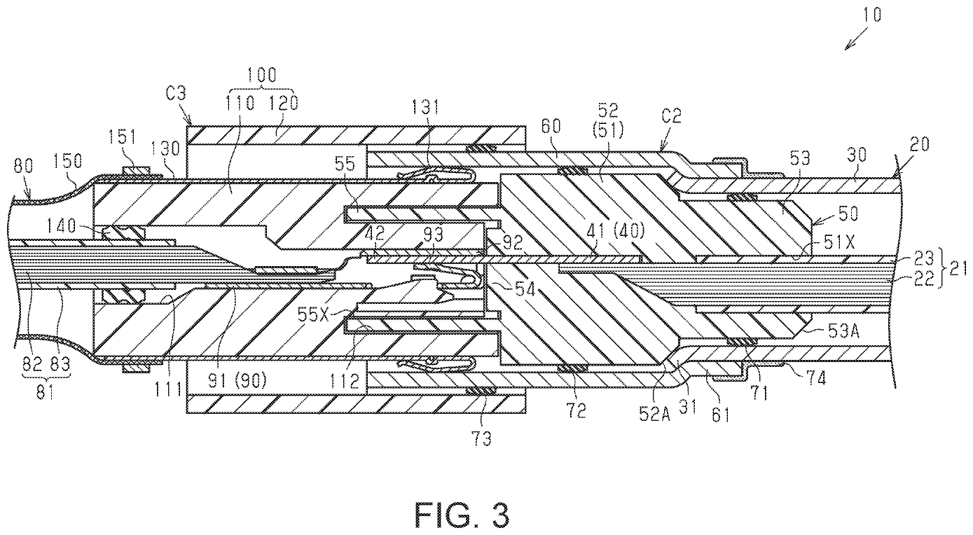

As shown in FIGS. 2 and 3, the wires 21 each include a core wire 22, which is made of a conductor, and an insulating coating 23 that surrounds the core wire 22. The core wire 22 may be a stranded wire obtained by twisting a plurality of metal wires, or a single core wire made of a single conductor, for example. The single core wire may be a columnar conductor, which is made of a single columnar metal rod having a solid internal structure, or a cylindrical conductor, which has a hollow internal structure, for example. The core wire 22 may be any combination of a stranded wire, a columnar conductor, and a cylindrical conductor. The core wire 22 of the present embodiment is a stranded wire. The material of the core wire 22 may be a metal material such as a copper-based or aluminum-based material, for example. The insulating coating 23 completely surrounds the outer peripheral surface of the core wire 22 in the circumferential direction, for example. The insulating coating 23 is made of an insulating material such as a synthetic resin, for example.

In the example shown in FIG. 4, a cross-section of each of the wires 21 taken along a plane orthogonal to the length direction of the wires 21 (e.g., the transverse section of each of the wires 21) has a circular shape. The cross-sectional shape of the wires 21 is not limited to being a circular shape, and can be any shape such as a semicircular shape, a polygonal shape, a square shape, or a flattened shape, for example.

### Configuration of Exterior Member 30

The exterior member 30 is elongated and has a ring-shaped transverse sectional shape. The exterior member 30 accommodates the wires 21 therein. In the example in FIG. 4, the exterior member 30 is formed so as to completely surround the plurality of wires 21 in the circumferential direction. In the example in FIG. 4, the wire harness 20 includes two wires 21, and the two wires 21 are accommodated in the exterior member 30. The exterior member 30 has a higher rigidity than the wires 21. For example, the exterior member 30 is a member having a higher bending rigidity than the wires 21. The exterior member 30 has a rigidity capable of maintaining the path of the wires 21, for example.

The exterior member 30 has electrical conductivity. The exterior member 30 may be a metal pipe made of a metal material, for example. The material of the exterior member 30 may be a metal material such as an aluminum-based material or a copper-based material, for example. The exterior member 30 has a function of protecting the wires 21 accommodated therein from flying objects and water droplets, and an electromagnetic shielding function of protecting the wires 21 from electromagnetic waves, for example.

The transverse sectional shape of the exterior member 30 can be any shape. For example, the transverse sectional shape of the exterior member 30 is a circular shape, a semicircular shape, a polygonal shape, a square shape, or a flattened shape. The transverse sectional shape of the exterior member 30 of the present embodiment is a circular shape. For example, the exterior member 30 is shaped as a circular ring with a circular outer edge.

As shown in FIG. 2, one end portion (here, the front end portion) of the exterior member 30 in the length direction (axial direction) has a guiding portion 31, for example. The guiding portion 31 is shaped such that the width of the opening of the exterior member 30 increases toward the front opening end of the exterior member 30. The guiding portion 31 is shaped such that the front end portion of the exterior member 30 is inclined outward in the radial direction of the exterior member 30. The guiding portion 31 is continuous entirely around the exterior member 30 in the circumferential direction, for example. The inner peripheral surface of the guiding portion 31 is an inclined surface.

### Configuration of Connector C2

The connector C2 includes terminals 40 attached to the front end portions of the wires 21, a connector housing 50 covering the wires 21 and the terminals 40, and an electrically conductive shielding member 60 (shield) that has a ring-shaped transverse sectional shape. The connector C2 includes a ring-shaped sealing member 71 (first seal), a ring-shaped sealing member 72 (second seal), a ring-shaped sealing member 73, and a sealing member 74 (third seal), for example.

### Configuration of Terminal 40

As shown in FIG. 3, each of the terminals 40 includes a wire connection portion 41 connected to the front end portion of the wire 21, and a terminal connection portion 42 to be connected to a terminal 90 of the wire harness 80, for example. The terminals 40 are each a single-piece component in which the wire connection portion 41 and the terminal connection portion 42 are continuous and integrated with each other, for example. The terminals 40 can be formed using a metal material such as copper, a copper alloy, aluminum, an aluminum alloy, or stainless steel, for example.

### Configuration of Wire Connection Portion 41

The wire connection portion 41 is electrically connected to the front end portion of the core wire 22. The wire connection portion 41 is connected to the front end portion of the core wire 22 exposed from the insulating coating 23, for example. The wire connection portion 41 is connected to the core wire 22 by crimping or ultrasonic welding, for example. The wire connection portion 41 and the core wire 22 are thus electrically and mechanically connected to each other.

### Configuration of Terminal Connection Portion 42

The terminal connection portion 42 is a male terminal, for example. The terminal connection portion 42 is shaped as flat plate, for example. For example, when the connector C2 and the connector C3 are fitted together, the terminal connection portion 42 is inserted into the terminal 90, which is a female terminal.

### Configuration of Connector Housing 50

As shown in FIG. 2, the connector housing 50 holds the wires 21 and the terminals 40. The connector housing 50 covers the core wires 22, the insulating coatings 23, and the terminals 40.

The connector housing 50 includes a body portion 51 and a tubular portion 55, for example. The body portion 51 and the tubular portion 55 of the connector housing 50 are continuous and integrated with each other, for example. The connector housing 50 is formed by insert molding performed using portions of the wires 21 and portions of the terminals 40 as insert portions, for example. The connector housing 50 is integrated with the wires 21 and the terminals 40, for example. The connector housing 50 can be formed using mold resin, for example. The connector housing 50 can be formed using a synthetic resin containing aromatic nylon resin or polybutylene terephthalate resin as a main component, for example. The connector housing 50 can be formed using a single type of material or using an appropriate combination of two or more types of materials.

### Configuration of Body Portion 51

The body portion 51 is elongated and extends along the length direction of the wires 21, for example. The body portion 51 has through holes 51X through which the wires 21 and the terminals 40 pass. As shown in FIG. 4, the body portion 51 has a plurality of through holes 51X through which the wires 21 respectively pass. The through holes 51X are spaced apart from each other. For this reason, the wires 21 are separated from each other while being held by the body portion 51. Note that the sealing member 74 is not shown in FIG. 4.

As shown in FIG. 2, the body portion 51 covers a region extending from the front end portion of the insulating coating 23 to a lengthwise intermediate portion of the terminal 40, for example. The body portion 51 covers the front end portions of the insulating coatings 23, the portions of the core wires 22 exposed from the insulating coatings 23, and the wire connection portions 41 of the terminals 40, in a state of close contact with such members, for example. The inner peripheral surface of each of the through holes 51X is in close contact with the outer peripheral surface of the corresponding insulating coatings 23, the outer peripheral surface of the corresponding core wire 22, and the outer peripheral surface of the corresponding wire connection portion 41, for example. The inner peripheral surface of each of the through holes 51X completely surrounds, in the circumferential direction, the outer peripheral surface of the corresponding insulating coating 23, the outer peripheral surface of the corresponding core wire 22, and the outer peripheral surface of the corresponding wire connection portion 41. The inner peripheral surface of each of the through holes 51X has a step conforming to the outer peripheral surface of the corresponding insulating coating 23, the outer peripheral surface of the corresponding core wire 22, and the outer peripheral surface of the corresponding wire connection portion 41, for example. In other words, the front end portion of the insulating coating 23, the portion of the core wire 22 exposed from the insulating coating 23, and the wire connection portion 41 are embedded in the body portion 51.

The body portion 51 includes a first end portion and a second end portion in the length direction (axial direction) of the body portion 51. The first end portion of the body portion 51 is the end portion closer to the terminal 40, out of the two end portions of the body portion 51 in the length direction. The second end portion of the body portion 51 is the end portion provided on the side opposite to the first end portion in the length direction of the body portion 51.

The body portion 51 includes a covering portion 52 provided in the first end portion of the body portion 51, a covering portion 53 provided in the second end portion of the body portion 51, and one or a plurality of (here, two) protrusions 54 provided in the first end portion of the body portion 51, for example. The covering portion 52 and the protrusions 54 are housed inside the shielding member 60. The covering portion 53 is housed inside the exterior member 30.

As shown in FIG. 5, the covering portion 52 can have an outer peripheral surface whose shape corresponds to the inner peripheral surface of the shielding member 60, for example. The outer peripheral surface of the covering portion 52 has a circular transverse sectional shape, for example. For example, the covering portion 52 is shaped as a circular ring. Note that the sealing member 73 is not shown in FIG. 5.

As shown in FIG. 4, the covering portion 53 has an outer peripheral surface whose shape corresponds to the inner peripheral surface of the exterior member 30, for example. The outer peripheral surface of the covering portion 53 has a circular transverse sectional shape, for example. For example, the covering portion 53 is shaped as a circular ring.

As shown in FIG. 2, the outer shape of the covering portion 52 is larger than the outer shape of the covering portion 53. For example, the outer circumference of the covering portion 52 is larger than the outer circumference of the covering portion 53. The outer circumference of the covering portion 52 is larger than the inner circumference of the exterior member 30, for example. The outer circumference of the covering portion 52 is larger than the inner circumference of the guiding portion 31, for example. For example, the outer circumference of the covering portion 52 is set such that the covering portion 52 cannot be inserted into the exterior member 30. The outer circumference of the covering portion 53 is set such that the covering portion 53 can be inserted into the exterior member 30. Here, the phrase “the outer circumference of the member A” in this specification refers to the length of one trip around the outer peripheral surface of the member A along the circumferential direction of the member A. Also, the phrase “the inner circumference of the member A” in this specification refers to the length of one trip around the inner peripheral surface of the member A along the circumferential direction of the member A.

The body portion 51 has a step formed by the outer peripheral surface of the covering portion 52 and the outer peripheral surface of the covering portion 53, for example. The outer peripheral surface of the covering portion 52 is concentric with the outer peripheral surface of the covering portion 53 in a plan view of the body portion 51 in the length direction, for example.

The covering portion 52 (second cover) includes a guide portion 52A (second guide) provided on the outer peripheral surface in the end portion (e.g., the rear end portion) connected to the covering portion 53, out of the two end portions of the covering portion 52 in the length direction, for example. The guide portion 52A is inclined so as to approach the wire 21 while extending toward the covering portion 53 in the length direction of the covering portion 52. The guide portion 52A is tapered so as to become narrower toward the rear end surface of the covering portion 52, for example. The guide portion 52A extends from a lengthwise intermediate portion of the covering portion 52 to the rear end surface of the covering portion 52. The guide portion 52A is continuous entirely around the covering portion 52 in the circumferential direction, for example. The outer circumference of the guide portion 52A is smaller than the outer circumference of the portion of the covering portion 52 excluding the guide portion 52A. The outer circumference of the guide portion 52A is larger than the inner circumference of the portion of the exterior member 30 excluding the guiding portion 41, for example. The guide portion 52A faces the inner peripheral surface of the guiding portion 31 in the length direction of the body portion 51, for example. The guide portion 52A has a function of guiding the portion of the covering portion 52 excluding the guide portion 52A into the shielding member 60 when the connector housing 50 is inserted into the shielding member 60. For example, since the connector housing 50 can be guided into the shielding member 60 along the inclined surface of the guide portion 52A, the connector housing 50 can be easily inserted into the shielding member 60.

Here, the term “facing” in this specification means that surfaces or members are at positions in front of each other, and includes not only the case where they completely face each other, but also the case where they partially face each other. Also, the term “facing” in this specification includes both the case where a different member is interposed between two facing members and the case where nothing is interposed between two facing members.

The covering portion 53 (first cover) includes a guide portion 53A (first guide) provided on the outer peripheral surface of the end portion (e.g., the rear end portion) of the covering portion 53 on the side opposite to the end portion connected to the covering portion 52, out of the two end portions of the covering portion 53 in the length direction. The guide portion 53A is provided in the second end portion of the body portion 51. The guide portion 53A is inclined so as to approach the wires 21 while extending away from the first end portion of body portion 51. The guide portion 53A is formed in a tapered shape that tapers toward the rear end surface of the covering portion 53, for example. The guide portion 53A extends from a lengthwise intermediate portion of the covering portion 53 to the rear end surface of the covering portion 53. The guide portion 53A is continuous entirely around the covering portion 53 in the circumferential direction, for example. The outer circumference of the guide portion 53A is smaller than the outer circumference of the portion of the covering portion 53 excluding the guide portion 53A. The guide portion 53A has a function of guiding the portion of the covering portion 53 excluding the guide portion 53A into the exterior member 30 when the connector housing 50 is inserted into the exterior member 30. For example, since the connector housing 50 can be guided into the interior of the exterior member 30 along the inclined surface of the guide portion 53A, the connector housing 50 can be easily inserted into the interior of the exterior member 30.

The protrusions 54 protrude forward from the front end surface of the body portion 51 (covering portion 52). One protrusion 54 is provided for each of the terminals 40. The protrusions 54 each cover a lengthwise intermediate portion of the corresponding terminal 40, in a state of close contact therewith. The outer circumference of each of the protrusions 54 is smaller than the outer circumference of the covering portion 52.

### Configuration of Tubular Portion 55

The tubular portion 55 protrudes forward from the front end surface of the body portion 51. The tubular portion 55 surrounds the terminals 40 exposed from the body portion 51 (e.g., the terminal connection portions 42). The tubular portion 55 surrounds the terminal connection portions 42 without coming into contact with the outer peripheral surfaces of the terminal connection portions 42. The front end portion of the tubular portion 55 projects forward beyond the front end surfaces of the terminal connection portions 42, for example. The front end portion of the tubular portion 55 projects forward beyond the front end surface of the shielding member 60, for example.

FIG. 5 shows an example of the arrangement of the terminals 40 in the connector housing 50. As shown in FIG. 5, the tubular portion 55 of the connector housing 50 can have one or a plurality of (two in the example in FIG. 5) through holes 55X. One terminal connection portion 42 is accommodated inside each of the through holes 55X. The inner peripheral surface of each of the through holes 55X is spaced apart from the outer peripheral surface of the corresponding terminal connection portion 42. The transverse sectional shape of the tubular portion 55 and the through holes 55X can be any shape. For example, the transverse sectional shape of the tubular portion 55 and the through holes 55X is a rectangular shape.

### Configuration of Shielding Member 60

As shown in FIG. 2, the shielding member 60 is elongated and has a ring-shaped transverse sectional shape. The connector housing 50 is accommodated in the shielding member 60. The shielding member 60 surrounds the wires 21, the terminals 40, and the connector housing 50. For example, the shielding member 60 completely surrounds the wires 21, the terminals 40, and the connector housing 50 in the circumferential direction. The outer circumference of the shielding member 60 is larger than the outer circumference of the exterior member 30, for example. The inner circumference of the shielding member 60 is larger than the outer circumference of the exterior member 30, for example. The shielding member 60 has a higher rigidity than the wires 21. The shielding member 60 is a member having a higher bending rigidity than the wires 21, for example. The shielding member 60 can be formed using a metal material such as an aluminum-based or copper-based material, for example. The shielding member 60 may be made of the same material as the exterior member 30 or a different material from the exterior member 30. The shielding member 60 has an electromagnetic shielding function of protecting the wires 21 from electromagnetic waves.

The shielding member 60 is attached to one lengthwise end portion (here, the front end portion) of the exterior member 30. The rear end portion of the shielding member 60 includes a connection portion 61 that is electrically and mechanically connected to the front end portion of the exterior member 30. The connection portion 61 is fitted around the front end portion of the exterior member 30. The outer circumference of the connection portion 61 is smaller than the outer circumference of the portion of the shielding member 60 excluding the connection portion 61, for example. The connection portion 61 shaped so as to extend along the outer peripheral surface of the front end portion of the exterior member 30 including the guiding portion 31, for example. The inner peripheral surface of the connection portion 61 is in close contact with the outer peripheral surface of the front end portion of the exterior member 30. The inner peripheral surface of the connection portion 61 is in close contact with the outer peripheral surface of the front end portion of the exterior member 30 over the entire circumference, for example. The connection portion 61 is attached to the outer peripheral surface of the front end portion of the exterior member 30 by being crimped around the front end portion of the exterior member 30, for example. The shielding member 60 is attached to the outer peripheral surface of the exterior member 30 by crimping the connection portion 61 provided at the rear end portion of the shielding member 60, for example. Accordingly, the shielding member 60 is in contact with the outer peripheral surface of the exterior member 30 and electrically connected to the exterior member 30.

As described above, the shielding member 60 and the exterior member 30 surround the connector housing 50. For example, the connector housing 50 is surrounded by the shielding member 60 and the exterior member 30 that have a higher rigidity than the wires 21.

### Configuration of Sealing Members 71, 72, 73

The sealing member 71 is attached to the outer peripheral surface of the covering portion 53. The sealing member 71 is provided inside the exterior member 30. The sealing member 71 is ring-shaped and is continuous entirely around the covering portion 53 in the circumferential direction. The sealing member 71 of the present embodiment is shaped as a circular ring. The sealing member 71 is configured to be elastically deformable. The sealing member 71 is in close contact with the outer peripheral surface of the covering portion 53, and is in close contact with the inner peripheral surface of the exterior member 30, for example. The sealing member 71 achieves sealing between the outer peripheral surface of the covering portion 53 and the inner peripheral surface of the exterior member 30.

The sealing member 72 is attached to the outer peripheral surface of the covering portion 52. The sealing member 72 is provided inside the shielding member 60. The sealing member 72 is ring-shaped and is continuous entirely around the covering portion 52 in the circumferential direction. The sealing member 72 of the present embodiment is shaped as a circular ring. The sealing member 72 is configured to be elastically deformable. The sealing member 72 is in close contact with the outer peripheral surface of the covering portion 52, and is in close contact with the inner peripheral surface of the shielding member 60, for example. The sealing member 72 achieves sealing between the outer peripheral surface of the covering portion 52 and the inner peripheral surface of the shielding member 60.

As shown in FIG. 3, the sealing member 73 is attached to the outer peripheral surface of the shielding member 60. The sealing member 73 is ring-shaped and is continuous entirely around the shielding member 60 in the circumferential direction. The sealing member 73 of the present embodiment is shaped as a circular ring. The sealing member 73 is configured to be elastically deformable. The sealing member 73 is in close contact with the outer peripheral surface of the shielding member 60, and is in close contact with the inner peripheral surface of an outer housing 120 of the connector C3, for example. The sealing member 73 achieves sealing between the outer peripheral surface of the shielding member 60 and the inner peripheral surface of the outer housing 120.

The sealing members 71, 72, and 73 are made of a rubber material, for example. Examples of materials that can be used for the sealing members 71, 72, and 73 include nitrile rubber, silicone rubber, urethane rubber, acrylic rubber, butyl rubber, and ethylene propylene rubber, for example.

### Configuration of Sealing Member 74

The sealing member 74 achieves sealing between the shielding member 60 and the exterior member 30. The sealing member 74 covers the outer peripheral surface of the shielding member 60 and the outer peripheral surface of the exterior member 30. The sealing member 74 continuously covers a region extending from the outer peripheral surface of the connection portion 61 to the outer peripheral surface of a portion of the exterior member 30 exposed from the connection portion 61. For example, the sealing member 74 continuously covers the outer peripheral surface of the rear end portion of the connection portion 61, the rear end surface of the connection portion 61, and the outer peripheral surface of a portion of the exterior member 30 exposed from the connection portion 61. For example, the sealing member 74 extends across a region spanning the outer peripheral surface of the shielding member 60 and the outer peripheral surface of the exterior member 30. The sealing member 74 is in close contact with the outer peripheral surface of the connection portion 61, the rear end surface of the connection portion 61, and the outer peripheral surface of the exterior member 30, for example. The sealing member 74 is continuous entirely around the shielding member 60 and the exterior member 30 in the circumferential direction. For example, a liquid gasket can be used as the sealing member 74. A silicone-based liquid gasket can be used as the liquid gasket, for example. After the rear end portion of the shielding member 60 is attached to the front end portion of the exterior member 30, the sealing member 74 is formed by applying a sealing agent such as a liquid gasket, for example. Note that the sealing member 74 can be formed using a conductive bonding material such as a brazing material, for example.

As shown in FIG. 1, the wire harness 20 is routed in a portion of the route of the compound wire harness 10 where routing is easy and the shape needs to be maintained (e.g., under the floor), for example. For this reason, in the wire harness 20, it is preferable that, out of the wires 21 and the exterior member 30, at least the exterior member 30 has a route regulating function. Also, in the wire harness 20, one lengthwise end portion (here, the front end portion) of the wire harness 20 is given a structure having excellent rigidity.

### Configuration of Wire Harness 80

The wire harness 80 electrically connects the wire harness 20 to the in-vehicle devices M2 and M3. The wire harness 80 constitutes a high-voltage circuit that enables the transmission and reception of high-voltage power between the wire harness 20 and the in-vehicle devices M2 and M3, for example. The entirety of the wire harness 80 in the length direction is routed in a vehicle compartment such as the engine room, for example. The wire harness 80 is provided in an area that does not require waterproofing, for example. The wire harness 80 includes one or a plurality of (two in the present embodiment) wires 81 and the connector C3 attached to rear end portions of the wires 81, for example. The wires 81 include a wire 81A whose rear end portion is connected to the connector C3, and a wire 81B and a wire 81C that are connected to the front end portion of the wire 81A, for example. The wire harness 80 includes a connector C4 attached to the front end portion of the wire 81C, and an exterior member 85 (second ring) that surrounds the wires 81A, 81B, and 81C, for example.

The rear end portion of the wire 81B is electrically connected to the wire 81A, and the front end portion of the wire 81B is integrated with the in-vehicle device M2. The rear end portion of the wire 81B is connected to an electric circuit E1 of the in-vehicle device M2, inside the in-vehicle device M2, for example. The rear end portion of the wire 81A (second-wire first end portion) is connected to the wire harness 20 via the connector C3, and the front end portion of the wire 81B (second-wire second end portion) is connected to the electric circuit E1 of the in-vehicle device M2, for example. The rear end portion of the wire 81C is electrically connected to the wire 81A, and the front end portion of the wire 81C is connected to the connector C4. The rear end portion of the wire 81A is connected to the wire harness 20 via the connector C3, and the front end portion of the wire 81C is connected to the in-vehicle device M3 via the connector C4, for example. The wires 81 branch from the one wire 81A into the two wires 81B and 81C at a lengthwise intermediate portion of the wires 81, for example. The connections between the wire 81A and the wires 81B and 81C are provided inside the exterior member 85, for example. In the compound wire harness 10, DC power supplied from the battery M1 is distributed to the wires 81B and 81C, and is supplied through the wires 81B and 81C to the in-vehicle devices M2 and M3.

### Configuration of Wire 81

As shown in FIG. 3, each of the wires 81 includes a core wire 82 made of a conductor, and an insulating coating 83 that covers the core wire 82. The wires 81 having a higher flexibility than the exterior member 30. The wires 81 have a higher bendability than the exterior member 30. The wires 81 have an elongated shape. The wires 81 are high-voltage wires that can support high-voltage and high-current power, for example. The wires 81 may each be a shielded wire or a non-shielded wire. The wires 81 of the present embodiment are each a non-shielded wire.

The core wire 82 can be a stranded wire, a columnar conductor, a cylindrical conductor, or any combination thereof, for example. The core wire 82 of the present embodiment is a stranded wire. The core wire 82 can be formed using a metal material such as a copper-based or aluminum-based material, for example. The insulating coating 83 completely covers the outer peripheral surface of the core wire 82 in the circumferential direction, for example. The insulating coating 83 is made of an insulating material such as a synthetic resin, for example.

The transverse sectional shape of the wires 81 can be any shape. For example, the transverse sectional shape of the wires 81 is circular, semicircular, polygonal, square, or flattened. The wires 81 of the present embodiment have a circular transverse sectional shape.

### Configuration of Connector C3

The connector C3 includes terminals 90 attached to the rear end portions of the wires 81, a connector housing 100 that holds the terminals 90, an electrically conductive inner shell 130, and a sealing member 140.

### Configuration of Terminal 90

The terminals 90 each include a wire connection portion 91 connected to the rear end portion of the corresponding wire 81, and a terminal connection portion 92 to be connected to the corresponding terminal 40 of the wire harness 20, for example. The terminals 90 are each a single component in which the wire connection portion 91 and the terminal connection portion 92 are continuous and integrated with each other, for example. The terminals 90 can be made of a metal material such as copper, a copper alloy, aluminum, an aluminum alloy, or stainless steel, for example.

### Configuration of Wire Connection Portion 91

The wire connection portion 91 is electrically connected to the rear end portion of the corresponding core wire 82. The wire connection portion 91 is connected to the rear end portion of the portion of the core wire 82 exposed from the insulating coating 83, for example. The wire connection portion 91 is connected to the core wire 82 by crimping or ultrasonic welding, for example. The wire connection portion 91 and the core wire 82 are thus electrically and mechanically connected to each other.

### Configuration of Terminal Connection Portion 92

The terminal connection portions 92 are each a female terminal, for example. The terminal connection portion 92 has a ring-shaped transverse sectional shape, for example. The terminal connection portion 92 is shaped as a quadrangular ring with a quadrangular outer edge shape, for example. For example, a connection piece 93 is provided inside the terminal connection portion 92. The connection piece 93 is elastically deformable due to being supported in a cantilever manner on the bottom wall of the terminal connection portion 92, for example.

The terminal connection portion 42, which is a male terminal, is inserted into the terminal connection portion 92, for example. At this time, the terminal connection portion 42 is sandwiched between the connection piece 93 and the inner surface of the terminal connection portion 42 inside the terminal connection portion 92. The terminal connection portion 42 and the terminal connection portion 92 are thus electrically connected to each other.

### Configuration of Connector Housing 100

The connector housing 100 holds the wires 81 and the terminals 90. The connector housing 100 surrounds the core wires 82, the insulating coatings 83, and the terminals 90. The connector housing 100 surrounds the rear end portions of the insulating coatings 83, the portions of the core wires 82 exposed from the insulating coatings 83, and the terminals 90, for example.

The connector housing 100 includes an inner housing 110 and an outer housing 120, for example. The connector housing 100 can be made of an insulating material such as a synthetic resin, for example. The connector housing 100 can be made of a synthetic resin such as polyolefin, polyamide, polyester, or ABS resin, for example.

### Configuration of Inner Housing 110

The inner housing 110 is elongated and extends along the length direction of the wires 81. The inner housing 110 can have an outer peripheral surface whose shape corresponds to the inner peripheral surface of the shielding member 60, and has a ring-shaped transverse sectional shape, for example. The inner housing 110 of the present embodiment is shaped as a circular ring with a circular outer edge shape.

The inner housing 110 has one or a plurality of (here, two) holding holes 111, for example. The holding holes 111 pass through the inner housing 110 in the length direction. One terminal 90 is held inside each of the holding holes 111. The terminals 90 are inserted into the holding holes 111 from the front side, for example. Also, a sealing member 140 attached to the outer peripheral surface of the insulating coating 83 is accommodated inside each of the holding holes 111, for example. A rubber ring can be used as the sealing member 140, for example. The sealing member 140 achieves sealing between the outer peripheral surface of the wire 81 and the inner peripheral surface of the holding bole 111.

The inner housing 110 has a groove 112 provided in the rear end portion of the inner housing 110, for example. The groove 112 extends from the rear end surface of inner housing 110 in a direction along the length direction of the inner housing 110. The size of the groove 112 is set so as to be capable of accommodating the tubular portion 55 of the connector C2, for example. For example, when the connector C2 and the connector C3 are connected, the rear end portion of the inner housing 110 is fitted inside the shielding member 60, and the tubular portion 55 is fitted in the groove 112.

### Configuration of Outer Housing 120

The outer housing 120 is elongated and extends along the length direction of the wires 81. The outer housing 120 can have an inner peripheral surface whose shape corresponds to the outer peripheral surface of the shielding member 60, and has a ring-shaped transverse sectional shape, for example. The outer housing 120 of the present embodiment is shaped as a circular ring with a circular outer edge. The size of the rear end portion of the outer housing 120 is set so as to be able to accommodate the shielding member 60. For example, when the connector C2 and the connector C3 are connected, the rear end portion of the outer housing 120 is fitted around the shielding member 60. At this time, the sealing member 73 is in close contact with the inner peripheral surface of the rear end portion of the outer housing 120, and the sealing member 73 is in close contact with the outer peripheral surface of the shielding member 60.

The outer housing 120 surrounds the inner housing 110. The outer housing 120 completely surrounds the inner housing 110 in the circumferential direction. The outer housing 120 is formed such that the front end portion of the inner housing 110 is exposed, for example. In other words, the front end portion of the inner housing 110 protrudes forward from the front end surface of the outer housing 120, for example. The outer housing 120 is connected to the inner housing 110 via the inner shell 130, for example.

### Configuration of Inner Shell 130

The inner shell 130 is elongated and extends along the length direction of the wires 81. The inner shell 130 can have a ring-shaped cross-section that extends along the outer peripheral surface of the inner housing 110, for example. The inner shell 130 of the present embodiment has a circular ring-shaped transverse sectional shape. The inner shell 130 surrounds the wires 81 and the terminals 90. The inner shell 130 can be made of a metal material such as a copper-based, aluminum-based, or iron-based material, for example. The inner shell 130 has an electromagnetic shielding function of protecting the wires 81 from electromagnetic waves.

The inner shell 130 is attached to the outer peripheral surface of the inner housing 110, for example. The rear end portion of the inner shell 130 is inserted into the shielding member 60, for example. A contact piece 131 is provided on the outer peripheral surface of the rear end portion of the inner shell 130. The contact piece 131 folded back from the rear end surface of the inner shell 130 so as to extend outward from the inner shell 130 and then forward, for example. The contact piece 131 is configured to be elastically deformable. The contact piece 131 comes into contact with the inner peripheral surface of the shielding member 60. The contact piece 131 is thus electrically connected to the shielding member 60.

The front end portion of the inner shell 130 is exposed from the outer housing 120, for example. The front end portion of the inner shell 130 protrudes forward from the front end surface of the outer housing 120.

### Configuration of Wire Harness 80

The wire harness 80 includes a shielding member 150 and a fixing member 151 that fixes the shielding member 150 to the connector housing 100, for example.

The shielding member 150 is elongated and extends along the length direction of the wires 81 and has a ring-shaped transverse sectional shape. The shielding member 150 surrounds the portions of the wires 81 that are exposed from the inner shell 130, for example. The shielding member 150 surrounds the wires 81 all together, for example. The shielding member 150 has a higher flexibility than the exterior member 30. The shielding member 150 has a higher bendability than the exterior member 30, for example. The shielding member 150 can be made of a flexible braided wire or metal foil, for example. The shielding member 150 can be made of a metal material such as a copper-based or aluminum-based material, for example. The shielding member 150 has an electromagnetic shielding function of protecting the wires 81 from electromagnetic waves.

The fixing member 151 fixes the shielding member 150 to the outer peripheral surface of the inner shell 130 while the shielding member 150 is in contact with the inner shell 130, for example. The fixing member 151 is attached to the outer peripheral surface of the inner shell 130. The fixing member 151 is ring-shaped and extends along the outer peripheral surface of inner shell 130. The fixing member 151 of the present embodiment is shaped as a circular ring. The fixing member 151 is fitted around the inner shell 130 in such a manner that the rear end portion of the shielding member 150 is sandwiched between the fixing member 151 and the outer peripheral surface of the inner shell 130. The fixing member 151 is tightened inward in the radial direction of the inner shell 130, such that the rear end portion of shielding member 150 is fixed in direct contact with the outer peripheral surface of inner shell 130. The shielding member 150 is thus electrically and mechanically connected to the inner shell 130. When the connector C2 and the connector C3 are connected, the shielding member 150, the inner shell 130, the shielding member 60, and the exterior member 30 are electrically connected to each other. A crimping ring, a binding band, or a tape member can be used as the fixing member 151, for example. The crimping ring can be made of a metal material such as an iron-based, aluminum-based, or copper-based material, for example.

### Configuration of Exterior Member 85

The exterior member 85 shown in FIG. 1 is overall elongated with a ring-shaped transverse sectional shape. The wires 81 and the shielding member 150 (see FIG. 3) are accommodated in the exterior member 85, for example. The exterior member 85 completely surrounds the shielding member 150 in the circumferential direction. The exterior member 85 includes branch portions 86 and 87 that extend along different routes, for example. The branch portion 86 surrounds the wire 81B, for example. The branch portion 87 surrounds the wire 81C, for example. The exterior member 85 protects the wires 81 housed therein from flying objects and the like. The exterior member 85 has a higher flexibility than the exterior member 30, for example. The exterior member 85 has a higher bendability than the exterior member 30, for example. The exterior member 85 can be a flexible corrugated tube made of resin or the like, a rubber waterproof cover, or a combination of such members, for example. The exterior member 85 may be constituted by a single component, or may be constituted by a combination of components.

The wire harness 80 has a higher flexibility than the wire harness 20. The wire harness 80 is routed in a section corresponding to the region including the in-vehicle devices M2 and M3, which is a section where there is little space for the wiring route of the compound wire harness 10 and routing is difficult, for example. The wire harness 80 is susceptible to vibration caused by the engine or the like, and is routed in a swing section where the compound wire harness 10 swings, for example. Since the wire harness 80 has excellent flexibility, the wire harness 80 absorbs the swing motion, and damage such as wire breakage of the wire harness 80 can be suppressed.

Next, actions and effects of the present embodiment will be described.

(1) The connector housing 50, which holds the terminals 40 connected to the front end portions of the wires 21, and the wires 21 are surrounded by the exterior member 30 and the shielding member 60 that have a higher rigidity than the wires 21. For this reason, the portion of the wire harness 20 that is connected to the wire harness 80 (e.g., one lengthwise end portion of the wire harness 20, which is the front end portion in this case) can have a structure with excellent rigidity. Accordingly, a flexible portion can be omitted from the end portion on at least one side out of the lengthwise end portions of the wire harness 20. As a result, the wire harness 20 can be installed in the vehicle V more easily than in the case where a flexible portion is provided at both end portions of the wire harness 20.

(2) The wire harness 20 and the wire harness 80 are connected to each other by connecting the connector C2 provided in the front end portion of the wire harness 20 to the connector C3 provided in the rear end portion of the wire harness 80. For this reason, the wire harness 20 having excellent rigidity and the wire harness 80 having excellent flexibility can be separated from each other. Accordingly, the wire harness 20 and the wire harness 80 can be installed in the vehicle V separately, and thus the compound wire harness 10 can be mounted in the vehicle V more easily than in the case where the wire harnesses 20 and 80 are installed in the vehicle V together.

(3) Also, the wire harness 20 and the wire harness 80 can be transported separately, thus making it possible to improve the efficiency of transportation of the compound wire harness 10.

(4) The wire harness 20 and the wire harness 80 can be separated, thus making it possible for the electromagnetic shield structure for the wire harness 20 and the electromagnetic shield structure for the wire harness 80 to be set individually. Also, the structure of the wire 21 and the structure of the wire 81 can be set individually.

(5) The sealing member 71 is provided to achieve sealing between the outer peripheral surface of the connector housing 50 and the inner peripheral surface of the exterior member 30, and the sealing member 72 is provided to achieving sealing between the outer peripheral surface of the connector housing 50 and the inner peripheral surface of the shielding member 60. These sealing members 71 and 72 can suitably suppress the entrance of a liquid such as water into the shielding member 60 and into the exterior member 30.

(6) The sealing member 74 for achieving sealing between the exterior member 30 and the shielding member 60 is provided at the connection between the exterior member 30 and the shielding member 60. Accordingly, it is possible to suitably suppress the case where a liquid such as water enters the exterior member 30 and the shielding member 60 through the connection between the exterior member 30 and the shielding member 60.

(7) The sealing member 74 is formed by applying a sealing agent after the rear end portion of the shielding member 60 and the front end portion of the exterior member 30 are connected. Accordingly, it is possible to suppress the case where the electrical connection between the shielding member 60 and the exterior member 30 is contaminated by the sealing agent. For this reason, the electromagnetic shielding function of the shielding member 60 and the exterior member 30 can be suitably maintained.

(8) The front end portion of the wire 81B is electrically connected to the electric circuit E1 of the in-vehicle device M2, inside the in-vehicle device M2. According to this configuration, the wire harness 80 is integrated with the in-vehicle device M2, thus making it possible to omit the task of connecting the wire harness 80 to the in-vehicle device M2. Accordingly, the compound wire harness 10 can be easily installed in the vehicle V even if there is little routing space around the in-vehicle device M2, for example. For this reason, it is possible to improve the ease of installation of the compound wire harness 10 in the vehicle V.

(9) Furthermore, the vibration resistance required for the connection between the connectors C2 and C3 can be reduced compared with the case where the front end portion of the wire 81B is connected to the in-vehicle device M2 via a connector. The connection structure of the connectors C2 and C3 can thus be simplified.

### OTHER EMBODIMENTS

The above embodiment can be implemented with modifications such as the following. The above embodiment and the following variations can be combined with each other as long as no technical contradiction arises.
The structures of the connectors C2 and C3 in the above embodiment can be changed as desired.

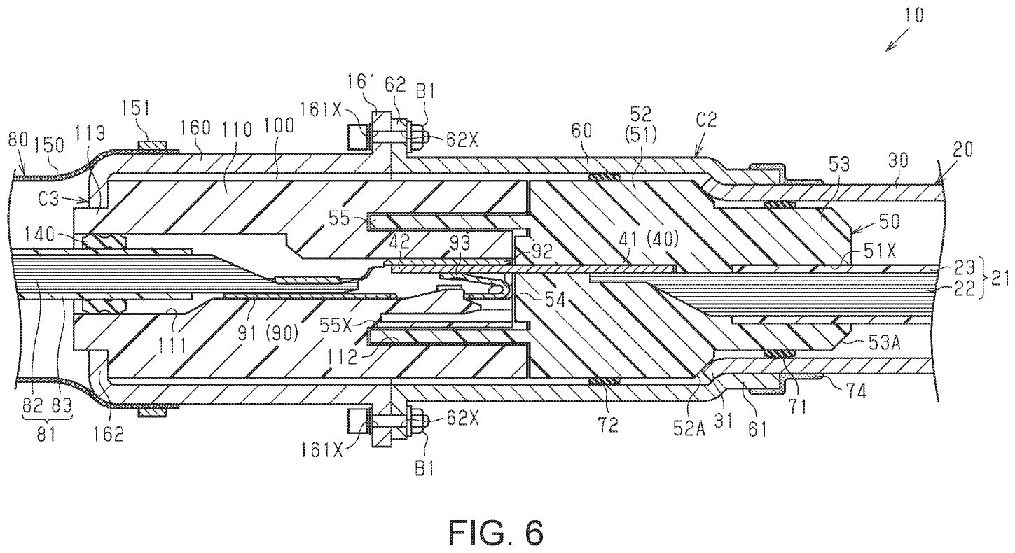

For example, as shown in FIG. 6, the connector C3 may include an electrically conductive shield shell 160, and the shielding member 60 of the connector C2 may include a fixing portion 62 to which the shield shell 160 is fixed.

The connector C3 of this variation includes terminals 90, a connector housing 100 that holds the terminals 90, and the shield shell 160, for example. The connector housing 100 of this variation is constituted by only the inner housing 110, for example. The inner housing 110 includes a protrusion 113 that protrudes forward from the front end surface of the inner housing 110, for example. The outer circumference of the protrusion 113 is smaller than the outer circumference of the portion of the inner housing 110 excluding the protrusion 113. For this reason, the outer peripheral surface of the front end portion of the inner housing 110 has a step formed by the outer peripheral surface of the protrusion 113 and the front end surface of the inner housing 110.

The shield shell 160 is elongated and extends along the length direction of the wires 81. The shield shell 160 can have a ring-shaped cross-section extending along the outer peripheral surface of the inner housing 110, for example. For example, the shield shell 160 has a circular ring-shaped transverse sectional shape. The shield shell 160 surrounds the inner housing 110. The shield shell 160 surrounds the wires 81 and the terminals 90. The shield shell 160 can be made of a metal material such as a copper-based, aluminum-based, or iron-based material, for example. The shield shell 160 has an electromagnetic shielding function of protecting the wires 81 from electromagnetic waves.

The shield shell 160 includes a fixing portion 161 provided in the rear end portion of the shield shell 160, and an engaging portion 162 provided in the front end portion of the shield shell 160.

The fixing portion 161 protrudes outward in the radial direction of the shield shell 160 from the outer peripheral surface of the rear end portion of the shield shell 160, for example. The fixing portion 161 is ring-shaped and is continuous entirely around the shield shell 160 in the circumferential direction, for example. The fixing portion 161 includes one or a plurality of (here, two) through holes 161X into which bolts B1 are inserted, for example. The through holes 161X pass through the fixing portion 161 along the length direction of the shield shell 160.

The engaging portion 162 protrudes inward in the radial direction of the shield shell 160 from the inner peripheral surface of the front end portion of the shield shell 160, for example. The engaging portion 162 engages with a step provided in the front end portion of the inner housing 110.

In the wire harness 80 of this variation, the shielding member 150 is electrically and mechanically connected to the outer peripheral surface of shield shell 160 by the fixing member 151.

The shielding member 60 of the connector C2 of this variation includes a fixing portion 62. The fixing portion 62 protrudes outward in the radial direction of the shielding member 60 from the outer peripheral surface of the front end portion of the shielding member 60, for example. The fixing portion 62 is ring-shaped and is continuous entirely around the shielding member 60 in the circumferential direction. The fixing portion 62 includes one or a plurality of (here, two) through holes 62X into which bolts B1 are inserted, for example. The two through holes 62X are provided at positions corresponding to the two through holes 161X. The through holes 62X pass through the fixing portion 62 along the length direction of the shielding member 60. The shielding member 60 is fixed to the shield shell 160 by inserting the bolts B1 into the through holes 62X and the through holes 161X. The connector C2 is thus fixed in a state of being connected to the connector C3.
In the above embodiment, the connector housing 50 of the connector C2 is formed by insert molding. For example, the connector housing 50 is formed so as to surround the core wire 22, the insulating coating 23, and the terminal 40, in a state of close contact with such members. However, the structure of the connector housing 50 is not limited to this. For example, as long as the connector housing 50 has a structure capable of holding the terminals 40, there are no particular limitations on other aspects of the structure. For example, the inner peripheral surfaces of the through holes 51X of the body portion 51 are not required to be in close contact with the outer peripheral surfaces of the core wires 22, the outer peripheral surfaces of the insulating coatings 23, and the outer peripheral surfaces of the terminals 40. For example, the tubular portion 55 may be omitted. As another example, the protrusion 54 of the body portion 51 may be omitted. As another example, the guide portion 52A of the covering portion 52 may be omitted. As another example, the guide portion 53A of the covering portion 53 may be omitted.
There are no particular limitations on the structure of the exterior member 30 in the above embodiment. For example, the guiding portion 31 may be omitted.
The exterior member 30 of the above embodiment is not limited to being a metal member made of a single material. For example, the exterior member 30 may be a composite member in which an electrically conductive shield layer is laminated on or embedded in a non-metallic pipe body.
In the above-described embodiment, the wire harness 20 includes two wires 21, but the present disclosure is not limited to this. The number of wires 21 can be changed according to the specifications of the vehicle V. For example, the number of wires 21 may be one, or may be three or more. For example, a low-voltage wire connecting a low-voltage battery to any of various low-voltage devices (e.g., a lamp or a car audio system) may be added as a wire constituting the wire harness 20.
The wire harness 80 of the above embodiment includes the shielding member 150 that surrounds the wires 81 all together. Alternatively, the wires 81 may be changed to shielded wires, and the shielding member 150 may be omitted, for example.
The wire 81 of the above embodiment has a configuration in which one wire 81A is branched into two wires 81B and 81C inside the exterior member 85. However, there are no particular limitations on the branch position (e.g., the power distribution position) of the wire 81.

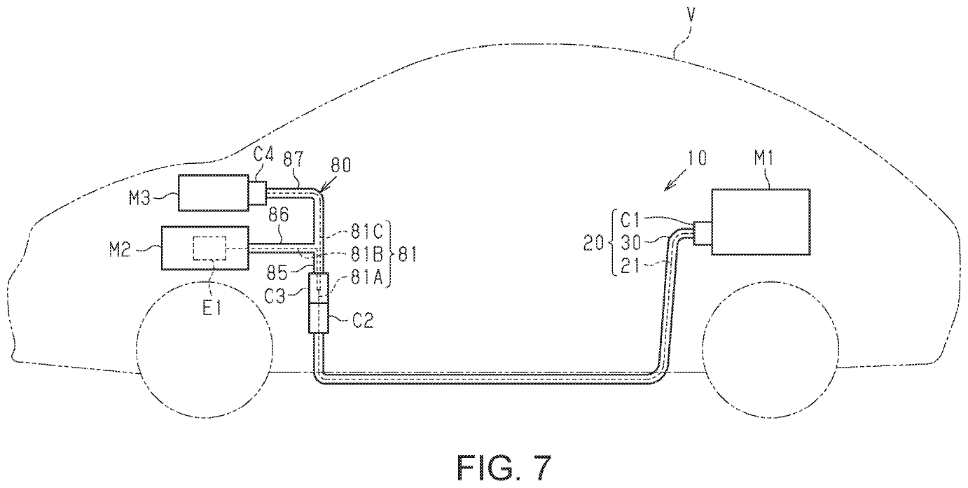

For example, as shown in FIG. 7, one wire 81A may be branched into two wires 81B and 81C inside the connector C3. For example, the connector C3 in this case has a power distribution function.
In the wire harness 80 of the above embodiment, one wire 81A is branched into two wires 81B and 81C, but one wire 81A may be branched into three or more wires.
In the above embodiment, the wire harness 80 has a branch structure in which one wire 81A is branched into two wires 81B and 81C. However, the structure of the wire harness 80 is not limited to this, and the branch structure may be omitted from the wire harness 80, for example. In this case, the wire harness 80 electrically connects the wire harness 20 to either one of the in-vehicle devices M2 and M3, for example.
In the wire harness 80 of the above embodiment, the front end portion of the wire 81B is integrated with the in-vehicle device M2, and the front end portion of the wire 81B is connected to the electric circuit E1 provided inside the in-vehicle device M2. However, the method of connecting the wire 81B to the in-vehicle device M2 is not limited to this.

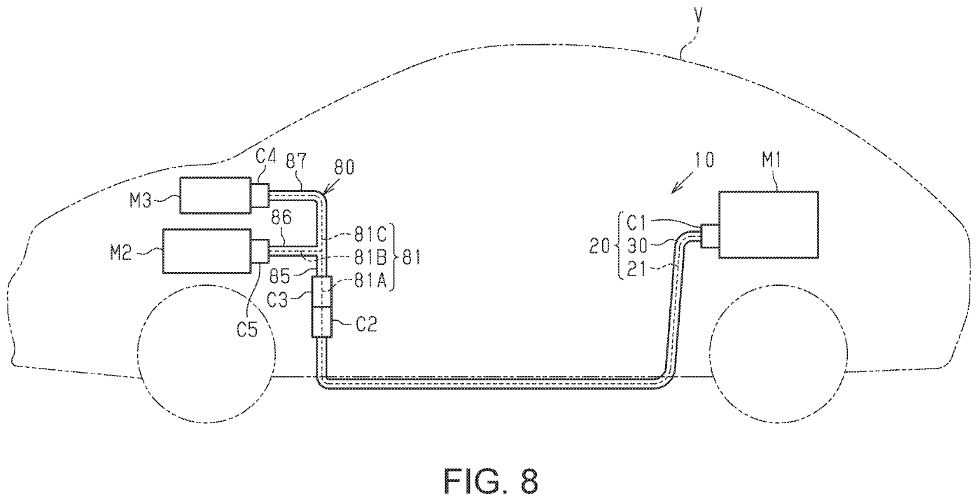

For example, as shown in FIG. 8, the front end portion of the wire 81B may be connected to the connector C5. In this case, the front end portion of the wire 81B is connected to the in-vehicle device M2 via the connector C5.
Although the sealing members 71, 72, 73, and 140 are embodied as rubber rings made of rubber in the above embodiment and variations, the present disclosure not limited to this. For example, ring members made of an elastic material other than rubber may be employed as the sealing members 71, 72, 73, and 140.
The sealing members 71, 72, 73, 74, and 140 of the above embodiment and variations may be omitted.
The positional relationship between the battery M1 and the in-vehicle devices M2 and M3 in the vehicle V is not limited to the relationship described in the above embodiment, and may be changed according to the configuration of the vehicle V as appropriate.

The first wires 21 of the wire harness 20 of the illustrated embodiment may also be referred to as a first non-coaxial wire bundle that includes a plurality of first wires 21 arranged non-coaxially with each other. The second wires 81 of the wire harness 80 of the illustrated embodiment may also be referred to as a second non-coaxial wire bundle that includes a plurality of second wires 81 arranged non-coaxially with each other. The combination of the connectors C2 and C3 and the connector housings 50 and 100 of the illustrated embodiment may also be referred to as a series coupling structure for connecting the wire harnesses 20 and 80 to each other in electrical series and/or coaxially. The connector C2 and the connector housing 50 of the wire harness 20 in combination with the connector C3 and the connector housing 100 of the wire harness 80 may also referred to as a mating pair of a connector plug and a connector jack.

The connector housing 50 of the illustrated embodiment may also be referred to as an insulating resin molded plug that is in close contact with part of the core wire 22 of each of the first wires 21, part of the insulating coating 23 of each of the first wires 21, and part of each of the terminals 40, and furthermore closes the open end of the exterior member 30. The guide portion 52A of the connector housing 50 of the illustrated embodiment may also be referred to as a stopper surface or a step surface that abuts against the open end of the exterior member 30 so as to position the connector housing 50 relative to the exterior member 30 in the lengthwise direction.

The exterior member 30 of the illustrated embodiment may also be referred to as a single first tubular shield. The shielding member 150 of the illustrated embodiment may also be referred to as a single second tubular shield. The inner shell 130 and the shield shell 160 of the illustrated embodiment may also be referred to as conductive shells.

The present disclosure encompasses implementation examples such as the following. Portions of the matter described in the following implementation examples may be omitted, and portions of the matter described in the following implementation examples may be selected or extracted and combined with each other.

### Supplementary Note 1

A compound wire harness according to some implementation examples of the present disclosure can include:
a first non-coaxial wire bundle including a plurality of first wires arranged non-coaxially with each other;
a second non-coaxial wire bundle including a plurality of second wires arranged non-coaxially with each other; and
a series coupling structure configured to detachably connect the first non-coaxial wire bundle and the second non-coaxial wire bundle to each other in electrical series.

### Supplementary Note 2

In one example of the present disclosure, the series coupling structure can include a mating pair of a connector plug and a connector jack configured to be attached to and detached from each other.

### Supplementary Note 3

In one example of the present disclosure, the compound wire harness can further include:
a single first tubular shield covering the first non-coaxial wire bundle;
a single second tubular shield covering the second non-coaxial wire bundle; and
a conductive shell configured to connect the single first tubular shield and the single second tubular shield in electrical series.

### Supplementary Note 4

In one example of the present disclosure, the series coupling structure can include an insulating resin molded plug configured to be in close contact with part of the first non-coaxial wire bundle and close an open end of the single first tubular shield.
The embodiments disclosed herein are intended to be considered as examples in all respects and not restrictive. The scope of the present disclosure is indicated by the scope of the claims rather than the meaning described above, and is intended to include all changes within the meaning and scope equivalent to the scope of the claims.

1. A first wire harness electrically connectable to a second wire harness for electrical connection to an in-vehicle device, the first wire harness comprising:
a first wire including a first core wire and a first insulating coating covering the first core wire;
a first terminal attached to an end of the first core wire and configured to be electrically connected to the second wire harness;
a first connector housing covering the first core wire, the first insulating coating, and the first terminal;
a first exterior ring that is electrically conductive, has a ring-shaped transverse sectional shape, and surrounds the first wire; and
a shield that is electrically conductive, has a ring-shaped transverse sectional shape, and is attached to a lengthwise end of the first exterior ring, wherein:
the first exterior ring and the shield have a higher rigidity than the first wire,
the shield is electrically connected to the first exterior ring, and
the first connector housing is surrounded by the first exterior ring and the shield.

2. The first wire harness according to claim 1, further comprising:
a first seal that is ring-shaped and attached to an outer peripheral surface of the first connector housing,
wherein the first seal is in close contact with the outer peripheral surface of the first connector housing and is in close contact with an inner peripheral surface of the first exterior ring.

3. The first wire harness according to claim 1, further comprising:
a second seal that is ring-shaped and attached to an outer peripheral surface of the first connector housing,
wherein the second seal is in close contact with the outer peripheral surface of the first connector housing and is in close contact with an inner peripheral surface of the shield.

4. The first wire harness according to claim 1, further comprising:
a third seal covering an outer peripheral surface of the first exterior ring and an outer peripheral surface of the shield, in a state of close contact,
wherein the third seal extends across a region spanning the outer peripheral surface of the first exterior ring and the outer peripheral surface of the shield.

5. The first wire harness according to claim 1, wherein:
the first connector housing includes:
a first end on a side corresponding to the first terminal; and
a second end on a side opposite to the first end, and
an outer peripheral surface of the second end includes a first guide inclined to approach the first wire while extending away from the first end.

6. The first wire harness according to claim 5, wherein:
a lengthwise end of the shield is fitted around a lengthwise end of the first exterior ring,
the first connector housing further includes:
a first cover accommodated inside the first exterior ring; and
a second cover accommodated inside the shield, and
the second cover has a larger outer shape than the first cover, the outer shape of the second cover being set to a size according to which the second cover is not insertable into the first exterior ring.

7. The first wire harness according to claim 6, wherein:
the first cover includes the first guide, and
an outer peripheral surface of an end of the second cover that is connected to the first cover includes a second guide inclined to approach the first wire while extending toward the first cover.

8. A compound wire harness for installation in a vehicle, the compound wire harness comprising:
a first wire harness; and
a second wire harness configured to be electrically connected to an in-vehicle device and electrically connected to the first wire harness,
the first wire harness including:
a first wire including a first core wire and a first insulating coating covering the first core wire;
a first terminal attached to an end of the first core wire;
a first connector housing covering the first core wire, the first insulating coating, and the first terminal;
a first exterior ring that is electrically conductive, has a ring-shaped transverse sectional shape, and surrounds the first wire; and
a shield that is electrically conductive, has a ring-shaped transverse sectional shape, and is attached to a lengthwise end of the first exterior ring, and
the second wire harness including:
a second wire including a second core wire and a second insulating coating covering the second core wire;
a second terminal attached to an end of the second core wire and configured to be electrically connected to the first terminal;
a second connector housing holding the second terminal; and
a second ring having a ring-shaped transverse sectional shape and surrounding the second wire,
wherein the first exterior ring and the shield have a higher rigidity than the first wire,
the shield is electrically connected to the first exterior ring,
the first connector housing is surrounded by the first exterior ring and the shield, and
the second wire and the second ring have a higher flexibility than the first exterior ring.

9. The compound wire harness according to claim 8, wherein:
the second wire harness is integrated with the in-vehicle device,
the second wire further includes:
a second-wire first end to which the second terminal is attached; and
a second-wire second end on a side opposite to the second-wire first end, and
the second-wire second end is configured to be electrically connected to an electric circuit of the in-vehicle device, inside the in-vehicle device.
